(19) United States
(12) Patent Application Publication
(10) Pub. No.: US 2025/0380626 A1
(43) Pub. Date: Dec. 18, 2025

(54) SYSTEM AND METHOD FOR DETERMINING CROP RESIDUE PARAMETERS WITHIN AN AGRICULTURAL FIELD

(71) Applicant: CNH Industrial America LLC, New Holland, PA (US)

(72) Inventor: Wenan Yuan, Willowbrook, IL (US)

(21) Appl. No.: 18/745,360

(22) Filed: Jun. 17, 2024

(51) Int. Cl. A01B 79/00; A01B 63/00; G06V 10/764; G06V 10/82; G06V 20/10; G06V 20/50

(52) U.S. Cl. CPC A01B 79/005; A01B 63/002; G06V 10/764; G06V 10/82; G06V 20/188; G06V 20/50

(57) ABSTRACT

An agricultural machine includes a computing system communicatively having one or more processors and one or more non-transitory computer-readable media that collectively store a machine-learned model configured to receive the image data and to process the image data to output classifications for pixels of the image data. Furthermore, the one or more non-transitory computer-readable media collectively store instructions that, when executed by the one or more processors, configure the computing system to perform operations. The operations, in turn, include receiving the image data from the imaging device and inputting the image data into the machine-learned model. Additionally, the operations include receiving the classifications for the pixels of the image data as an output of the machine-learned model and identifying residue bunches or residue evenness of within the portion of the field based on the classification for the pixels.

### FIELD OF THE INVENTION

The present generally to measuring crop residue in an agricultural field and, more particularly, to measuring crop residue in a field from imagery of the agricultural field using a machine-learned model.

### BACKGROUND OF THE INVENTION

Crop residue generally refers to the vegetation (e.g., straw, chaff, husks, cobs, etc.) remaining on the soil surface following the performance of a given agricultural operation, such as a harvesting operation or a tillage operation. For various reasons, it is important to maintain a given amount of crop residue within a field following an agricultural operation. Specifically, crop residue remaining within the field can help maintain the content of organic matter within the soil and can also serve to protect the soil from wind and water erosion. However, in some cases, leaving an excessive amount of crop residue within a field can hurt the productivity potential of the soil, such as by slowing down the warming of the soil at planting time and/or by slowing down seed germination. As such, the ability to monitor and/or adjust the amount of crop residue remaining within a field can be important to maintaining a healthy and productive field, particularly when it comes to performing tillage operations.

In this regard, systems and methods have been developed for determining crop residue coverage or other residue parameters of an agricultural field, such as through the use of image data. While such systems and methods work well, further improvements are needed.

Accordingly, an improved system and method for determining crop residue parameters would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to an agricultural machine. The agricultural machine includes a frame and an imaging device supported on the frame, with the imaging device configured to capture image data depicting a portion of a field across which the agricultural machine is traveling. Furthermore, the agricultural machine includes a computing system communicatively coupled to the imaging device. In this respect, the computing system includes one or more processors and one or more non-transitory computer-readable media that collectively store a machine-learned model configured to receive the image data and to process the image data to output classifications for pixels of the image data and instructions that, when executed by the one or more processors, configure the computing system to perform operations. The operations, in turn, include receiving the image data from the imaging device and inputting the image data into the machine-learned model. Additionally, the operations include receiving the classifications for the pixels of the image data as an output of the machine-learned model and identifying residue bunches or residue evenness within the portion of the field based on the classification for the pixels.

In another aspect, the present subject matter is directed to a computing system including one or more processors and one or more non-transitory computer-readable media that collectively store a machine-learned model configured to receive image data and to process the image data to output classifications for pixels of the image data. Moreover, the one or more non-transitory computer-readable media collectively store instructions that, when executed by the one or more processors, configure the computing system to perform operations. The operations, in turn, include receiving the image data from an imaging device supported on an agricultural machine, the image data depicting a portion of a field across which the agricultural machine is traveling. In addition, the operations include inputting the image data into the machine-learned model and receiving the classifications for the pixels of the image data as an output of the machine-learned model. Furthermore, the operations include identifying residue bunches or residue evenness within the portion of the field based on the classification for the pixels.

In a further aspect, the present subject matter is directed to a computing-implemented method. The method includes receiving, with a computing system comprising one or more computing devices, image data depicting a portion of a field across which an agricultural machine is traveling from an imaging device supported on the agricultural machine. Additionally, the method includes inputting, with the computing system, the image data into a machine-learned model configured to receive the image data and process the image data to output classifications for pixels of the image data. Moreover, the method includes receiving, with the computing system, the classifications for the pixels of the image data as an output of the machine-learned model. In addition, the method includes identifying, with the computing system, residue bunches or residue evenness of within the portion of the field based on classifications for the pixels; and controlling an operation of the agricultural machine based on the identification of the residue bunches or the residue evenness.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a top view of one embodiment of an agricultural machine in accordance with aspects of the present subject matter;

FIG. 2 illustrates a partial, perspective view of the agricultural machine shown in FIG. 1;

FIG. 3 illustrates a schematic view of one embodiment of a computing system in accordance with aspects of the present subject matter;

FIG. 4 illustrates a schematic view of one embodiment of a computing system in accordance with aspects of the present subject matter; and

FIG. 5 illustrates a flow diagram of one embodiment of a method for determining crop residue parameters within an agricultural field in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield still a further embodiment. Thus, it is intended that the present invention covers such modifications and variations as come within the scope of the appended claims and their equivalents.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to systems and methods that determine crop residue parameters within an agricultural field from image data of the field. In particular, the present subject matter is directed to systems and methods that include or otherwise leverage a machine-learned model (e.g., a convolutional neural network, a transformer, etc.) to identify residue bunches present within or the residue evenness a portion of an agricultural field based at least in part on image data of such portion of the field captured by an imaging device. As used herein, residue bunches are groups of clusters of residue pieces that are positioned closely together or are touching each other to form a clump or mass of residue. The presence of residue bunches may hinder or otherwise affect the agricultural performance of the field. Additionally, residue evenness refers to how consistently, balanced, regularly, or evenly the residue is distributed across a given portion of the field. According to an aspect of the present disclosure, the machine-learned model can be configured to receive image data and to process the image data to classify each pixel within the image data as having one of a residue classification or a not residue classification. Based on such classification, the disclosed systems and method can identify residue bunches or residue evenness, such as based on the number of pixels having the residue classification that are directly in contact with each other or the density of pixels having the residue classification.

In particular, in one example, a computing system can receive image data that depicts a portion of a field. For example, the image data can be captured by an imaging device (e.g., a camera) positioned in a (at least partially) downward-facing direction and supported on or otherwise physically coupled to an agricultural machine (e.g., a work vehicle or an implement towed by the work vehicle) through the field. The computing system can respectively input the image data into the machine-learned model and, in response, receive an output of the machine-learned model.

Further, the systems and methods of the present disclosure can control the operation of the agricultural machine based on the identification of residue bunches or the residue evenness within the imaged portion of the field. For example, the relative positioning of, the penetration depth of, the force being applied to, and/or any other operational parameters associated with one or more ground-engaging tools can be modified based on the presence of residue bunches or residue evenness, thereby breaking up such residue bunches and/or more evenly spreading the residue out. Thus, the systems and methods of the present disclosure can enable improved real-time control that measures and accounts for crop residue bunches or residue evenness during field operations.

Using the classifications of pixels within image data received from a machine-learned model, such as a convolutional neural network or a transformer, the systems and methods of the present disclosure can identify the presence of crop residue bunches or the residue evenness with greater accuracy. These more accurate identifications of crop residue can enable improved and/or more precise control of the agricultural machine to eliminate residue bunches within and/or improve the residue evenness of an agricultural field and, as a result, lead to superior agricultural outcomes.

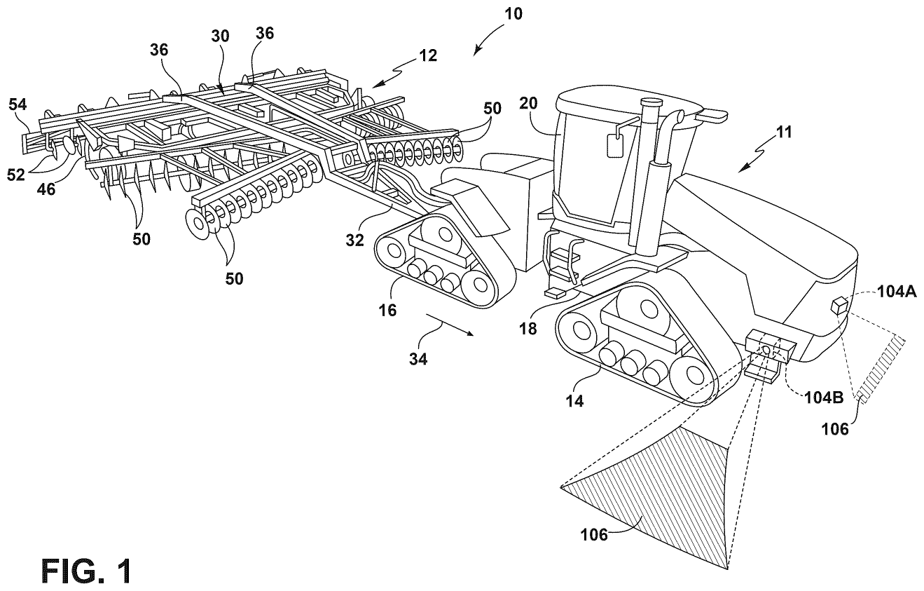

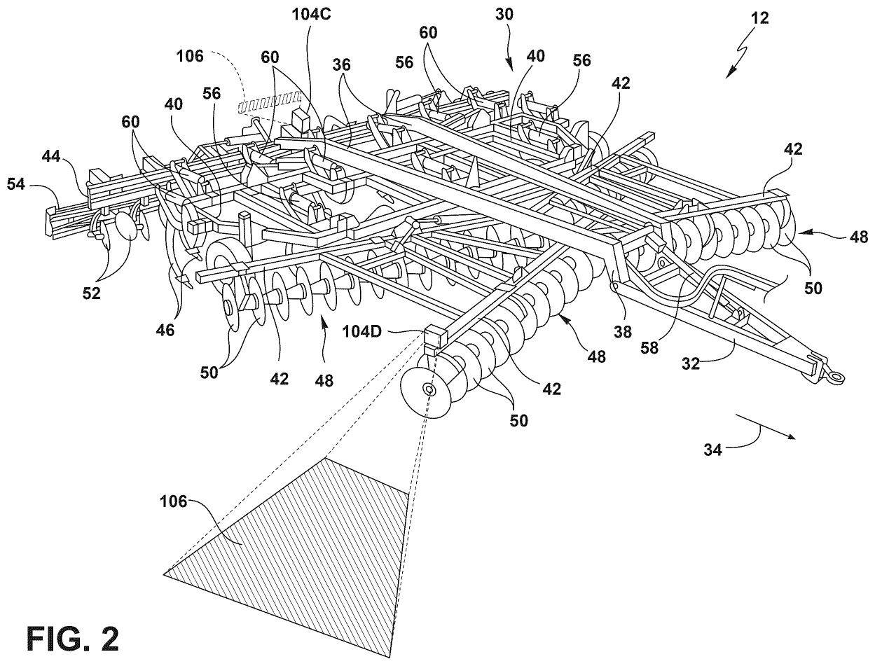

Referring now to the drawings, FIGS. 1 and 2 illustrate differing views of one embodiment of an agricultural machine 10 in accordance with aspects of the present subject matter. In the illustrated embodiment, agricultural machine 10 is configured as a work vehicle 11 (e.g., an agricultural tractor) and an associated agricultural implement 12 (e.g., a tillage implement). In this respect, the work vehicle 11 may be configured to tow the agricultural implement 12 across a field in a direction of travel (e.g., as indicated by arrow 34 in FIG. 1). However, in alternative embodiments, the agricultural machine 10 may correspond to any other suitable machine, such as any other suitable vehicle/implement combination, only an agricultural vehicle (e.g., an agricultural harvester, a self-propelled sprayer, etc.), or only an agricultural implement (e.g., a tillage implement). Additionally, in such embodiments, the agricultural machine 10 may be an unmanned aerial vehicle (UAV) suitable for use in an agricultural field.

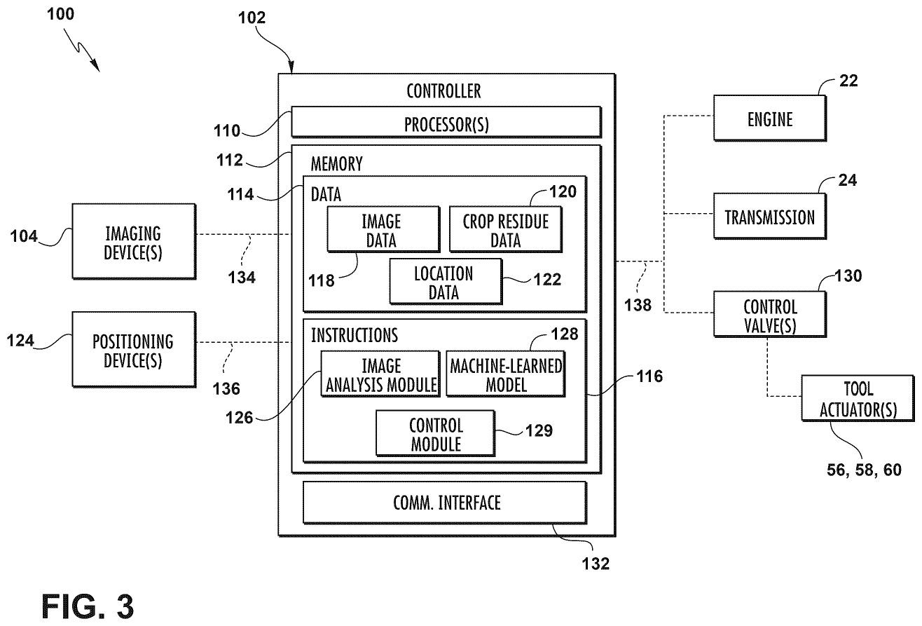

As particularly shown in FIG. 1, the work vehicle 11 includes a pair of front track assemblies 14, a pair of rear track assemblies 16 and a frame or chassis 18 coupled to and supported by the track assemblies 14, 16. An operator's cab 20 may be supported by a portion of the chassis 18 and may house various input devices for permitting an operator to control the operation of one or more components of the work vehicle 11 and/or one or more components of the implement 12. Additionally, the work vehicle 11 may include an engine 22 (FIG. 3) and a transmission 24 (FIG. 3) mounted on the chassis 18. The transmission 24 may be operably coupled to the engine 22 and may provide variably adjusted gear ratios for transferring engine power to the track assemblies 14, 16 via a drive axle assembly (not shown) (or via axles if multiple drive axles are employed).

Moreover, as shown in FIGS. 1 and 2, the implement 12 may generally include a carriage frame assembly 30 configured to be towed by the work vehicle 11 via a pull hitch or tow bar 32 in a travel direction of the vehicle (e.g., as indicated by arrow 34). The carriage frame assembly 30 may be configured to support a plurality of ground-engaging tools, such as a plurality of shanks, disk blades, leveling blades, basket assemblies, and/or the like. In several embodiments, the various ground-engaging tools may be configured to perform a tillage operation across the field along which the implement 12 is being towed.

As particularly shown in FIG. 2, the carriage frame assembly 30 may include aft extending carrier frame members 36 coupled to the tow bar 32. In addition, reinforcing gusset plates 38 may be used to strengthen the connection between the tow bar 32 and the carrier frame members 36. In several embodiments, the carriage frame assembly 30 may generally function to support a central frame 40, a forward frame 42 positioned forward of the central frame 40 in the direction of travel 34 of the work vehicle 11, and an aft frame 44 positioned aft of the central frame 40 in the direction of travel 34 of the work vehicle 11. As shown in FIG. 2, in one embodiment, the central frame 40 may correspond to a shank frame configured to support a plurality of ground-engaging shanks 46. In such an embodiment, the shanks 46 may be configured to till the soil as the implement 12 is towed across the field. However, in other embodiments, the central frame 40 may be configured to support any other suitable ground-engaging tools.

Additionally, as shown in FIG. 2, in one embodiment, the forward frame 42 may correspond to a disk frame configured to support various gangs or sets 48 of disk blades 50. In such an embodiment, each disk blade 50 may, for example, include both a concave side (not shown) and a convex side (not shown). In addition, the various gangs 48 of disk blades 50 may be oriented at an angle relative to the travel direction 34 of the work vehicle 11 to promote more effective tilling of the soil. However, in other embodiments, the forward frame 42 may be configured to support any other suitable ground-engaging tools.

As another example, ground-engaging tools can include harrows which can include, for example, a number of tines or spikes, which are configured to level or otherwise flatten any windrows or ridges in the soil. The implement 12 may include any suitable number of harrows. Some embodiments of the implement 12 may not include any harrows.

Moreover, similar to the central and forward frames 40, 42, the aft frame 44 may also be configured to support a plurality of ground-engaging tools. For instance, in the illustrated embodiment, the aft frame is configured to support a plurality of leveling blades 52 and rolling (or crumbler) basket assemblies 54. However, in other embodiments, any other suitable ground-engaging tools may be coupled to and supported by the aft frame 44, such as a plurality of closing disks.

In addition, the implement 12 may also include any number of suitable actuators (e.g., hydraulic cylinders) for adjusting the relative positioning of, the penetration depth of, and/or force being applied to the various ground-engaging tools (e.g., ground-engaging tools 46, 50, 52, 54). For instance, the implement 12 may include one or more first actuators 56 coupled to the central frame 40 for raising or lowering the central frame 40 relative to the ground, thereby allowing the penetration depth and/or the force being applied to the shanks 46 to be adjusted. Similarly, the implement 12 may include one or more second actuators 58 coupled to the disk forward frame 42 to adjust the penetration depth and/or the force being applied to the disk blades 50. Moreover, the implement 12 may include one or more third actuators 60 coupled to the aft frame 44 to allow the aft frame 44 to be moved relative to the central frame 40, thereby allowing the relevant operating parameters of the ground-engaging tools 52, 54 supported by the aft frame 44 (e.g., the force being applied to and/or the penetration depth) to be adjusted.

It should be appreciated that the configuration of the agricultural machine 10 described above and shown in FIGS. 1 and 2 are provided only to place the present subject matter in an exemplary field of use. Thus, it should be appreciated that the present subject matter may be readily adaptable to any manner of agricultural machine configuration.

Additionally, in accordance with aspects of the present subject matter, the agricultural machine 10 (e.g., the work vehicle 11 and/or the implement 12) may include one or more imaging devices coupled thereto and/or supported thereon for capturing images or other image data associated with the field as the agricultural machine 10 travels across the field, such as to perform an agricultural operation (e.g., a tillage operation) thereon. Specifically, in several embodiments, the imaging device(s) may be provided in operative association with agricultural machine 10 such that the imaging device(s) has a field of view directed towards a portion(s) of the field disposed in front of, behind, and/or underneath some portion of the agricultural machine 10 such as, for example, alongside one or both of the sides of the agricultural machine 10 as the agricultural machine 10 travels across the field. As such, the imaging device(s) may capture images from agricultural machine 10 of one or more portion(s) of the field being passed by the agricultural machine 10.

In general, the imaging device(s) may correspond to any suitable device(s) configured to capture images or other image data of the field that allow the soil of the field to be distinguished from the crop residue remaining on top of the soil. For instance, in several embodiments, the imaging device(s) may correspond to any suitable camera(s), such as single-spectrum camera or a multi-spectrum camera configured to capture images, for example, in the visible light range and/or infrared spectral range. Additionally, in a particular embodiment, the camera(s) may correspond to a single lens camera configured to capture two-dimensional images or a stereo camera(s) having two or more lenses with a separate image sensor for each lens to allow the camera(s) to capture stereographic or three-dimensional images. Alternatively, the imaging device(s) may correspond to any other suitable image capture device(s) and/or vision system(s) that is capable of capturing “images” or other image-like data that allow the crop residue existing on the soil to be distinguished from the soil. For example, the imaging device(s) may correspond to or include radio detection and ranging (RADAR) sensors and/or light detection and ranging (LIDAR) sensors.

The agricultural machine 10 may include any number of imaging device(s) 104 provided at any suitable location that allows images of the field to be captured as the agricultural machine 10 travels across the field. For instance, FIGS. 1 and 2 illustrate examples of various locations for mounting one or more imaging device(s) 104 for capturing images of the field. Specifically, as shown in FIG. 1, in one embodiment, one or more imaging devices 104A may be coupled to the front of the work vehicle 11 such that the imaging device(s) 104A has a field of view 106 that allows it to capture images of an adjacent area or portion of the field disposed in front of the work vehicle 11. For instance, the field of view 106 of the imaging device(s) 104A may be directed outwardly from the front of the work vehicle 11 along a plane or reference line that extends generally parallel to the travel direction 34 of the work vehicle 11. In addition to such imaging device(s) 104A (or as an alternative thereto), one or more imaging devices 104B may also be coupled to one of the sides of the work vehicle 11 such that the imaging device(s) 104B has a field of view 106 that allows it to capture images of an adjacent area or portion of the field disposed along such side of the work vehicle 11. For instance, the field of view 106 of the imaging device(s) 104B may be directed outwardly from the side of the work vehicle 11 along a plane or reference line that extends generally perpendicular to the travel direction 34 of the work vehicle 11.

Similarly, as shown in FIG. 2, in one embodiment, one or more imaging devices 104C may be coupled to the rear of the implement 12 such that the imaging device(s) 104C has a field of view 106 that allows it to capture images of an adjacent area or portion of the field disposed aft of the implement. For instance, the field of view 106 of the imaging device(s) 104C may be directed outwardly from the rear of the implement 12 along a plane or reference line that extends generally parallel to the travel direction 34 of the work vehicle 11. In addition to such imaging device(s) 104C (or as an alternative thereto), one or more imaging devices 104D may also be coupled to one of the sides of the implement 12 such that the imaging device(s) 104D has a field of view 106 that allows it to capture images of an adjacent area or portion of the field disposed along such side of the implement 12. For instance, the field of view 106 of the imaging device 104D may be directed outwardly from the side of the implement 12 along a plane or reference line that extends generally perpendicular to the travel direction 34 of the work vehicle 11.

In alternative embodiments, the imaging device(s) 104 may be installed at any other suitable location that allows the device(s) to capture images of an adjacent portion of the field, such as by installing an imaging device(s) at or adjacent to the aft end of the work vehicle 11 and/or at or adjacent to the forward end of the implement 12. It should also be appreciated that, in several embodiments, the imaging devices 104 may be specifically installed at locations on the agricultural machine 10 to allow images to be captured of the field both before and after the performance of a field operation by the agricultural machine 10. For instance, by installing the imaging device 104A at the forward end of the work vehicle 11 and the imaging device 104C at the aft end of the implement 12, the forward imaging device 104A may capture images of the field before the performance of the field operation while the aft imaging device 104C may capture images of the same portions of the field following the performance of the field operation. Such before and after images may be analyzed, for example, to evaluate the effectiveness of the operation being performed within the field, such as by allowing the disclosed system to evaluate the presence of residue bunches within or the residue evenness of the field before and after the tillage operation.

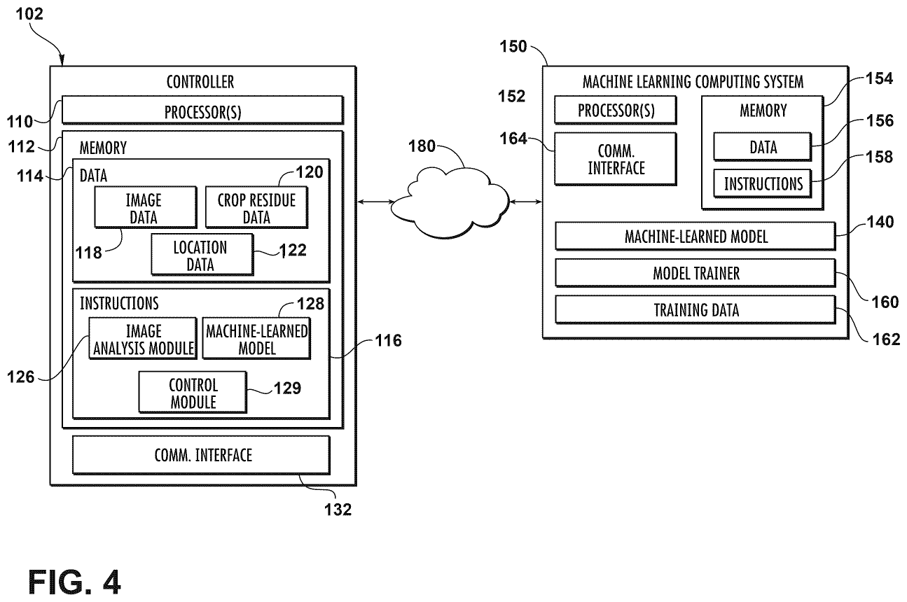

Referring now to FIGS. 3 and 4, schematic views of embodiments of a computing system 100 are illustrated in accordance with aspects of the present subject matter. In general, the system 100 will be described herein with reference to agricultural machine 10 (e.g., the work vehicle 11 and the implement 12) described above with reference to FIGS. 1 and 2. However, the disclosed system 100 may generally be utilized with work vehicles having any suitable vehicle configuration and/or implements have any suitable implement configuration.

In several embodiments, the system 100 may include one or more controllers 102 and various other components configured to be communicatively coupled to and/or controlled by the controller(s) 102, such as one or more imaging devices 104 and/or various components of the agricultural machine 10. In some embodiments, the controller(s) 102 is physically coupled to the agricultural machine 10 (e.g., the work vehicle 11 and/or the implement 12). In other embodiments, the controller(s) 102 is not physically coupled to the agricultural machine 10 (e.g., the controller(s) 102 may be remotely located from the work vehicle 11 and/or the implement 12) and instead may communicate with the agricultural machine 10 over a wireless network.

As will be described in greater detail below, the controller(s) 102 may be configured to leverage a machine-learned model 128 to classify pixels within image data depicting a portion of an agricultural field based at least in part on the image data of such portion of the field captured by one or more imaging devices 104. In particular, FIG. 3 illustrates a computing environment in which the controller(s) 102 can operate to determine crop residue data 120 for at least a portion of a field based on image data 118 newly received from one or more imaging devices 104 and, further, to control one or more components of an agricultural machine (e.g., engine 22, transmission 24, control valve(s) 130, etc.) based on the crop residue data 120. That is, FIG. 3 illustrates a computing environment in which the controller(s) 102 is actively used in conjunction with an agricultural machine (e.g., during the operation of the agricultural machine within a field). As will be discussed further below, FIG. 4 depicts a computing environment in which the controller(s) 102 can communicate over a network 180 with a machine-learning computing system 150 to train and/or receive a machine-learned model 128. Thus, FIG. 4 illustrates the operation of the controller(s) 102 to train a machine-learned model 128 and/or to receive a trained machine-learned model 128 from a machine-learning computing system 150 (e.g., FIG. 4 shows the “training stage”) while FIG. 3 illustrates the operation of the controller(s) 102 to use the machine-learned model 128 to classify pixels within received image data of a field (e.g., FIG. 3 shows the “inference stage”).

Referring first to FIG. 3, in general, the controller(s) 102 may correspond to any suitable processor-based device(s), such as a computing device or any combination of computing devices. Thus, as shown in FIG. 3, the controller(s) 102 may generally include one or more processor(s) 110 and associated memory devices 112 configured to perform a variety of computer-implemented functions (e.g., performing the methods, steps, algorithms, calculations and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 112 may generally include memory element(s) including, but not limited to, computer-readable medium (e.g., random access memory (RAM)), computer-readable non-volatile medium (e.g., a flash memory), a floppy disk, a compact disc-read only memory (CD-ROM), a magneto-optical disk (MOD), a digital versatile disc (DVD) and/or other suitable memory elements. Such memory 112 may generally be configured to store information accessible to the processor(s) 110, including data 114 that can be retrieved, manipulated, created, and/or stored by the processor(s) 110 and instructions 116 that can be executed by the processor(s) 110.

In several embodiments, the data 114 may be stored in one or more databases. For example, the memory 112 may include an image database 118 for storing image data received from the imaging device(s) 104. For example, the imaging device(s) 104 may be configured to continuously or periodically capture images of adjacent portion(s) of the field as an operation is being performed with the field. In such an embodiment, the images transmitted to the controller(s) 102 from the imaging device(s) 104 may be stored within the image database 118 for subsequent processing and/or analysis. As used herein, the term image data may include any suitable type of data received from the imaging device(s) 104 that allows for the presence of residue bunches within or the residue evenness of the field to be identified, including photographs and other image-related data (e.g., scan data and/or the like).

Additionally, as shown in FIG. 3, the memory 112 may include a crop residue database 120 for storing information related to the identification of crop residue bunches within or the residue evenness of the field being processed. For example, as indicated above, based on the image data received from the imaging device(s) 104, the controller(s) 102 may be configured to classify the pixels of the image data as having one of a residue classification or a not residue classification. The classifications of the pixels may then be stored within the crop residue database 120 for subsequent processing and/or analysis. For example, as will be described below, such classifications are used to identify the presence of residue bunches and/or one or more parameters associated with such residue bunches, such as their size, shape, location, etc. Such classifications may also be used to identify the residue evenness of a given portion of the field and/or one or more parameters associated with such residue evenness.

Moreover, in several embodiments, the memory 112 may also include a location database 122 storing location information about the agricultural machine 10 and/or information about the field being processed (e.g., a field map). Specifically, as shown in FIG. 3, the controller(s) 102 may be communicatively coupled to a positioning device(s) 124 installed on or within the agricultural machine 10 (e.g., the work vehicle 11 and/or on or within the implement 12). For example, in one embodiment, the positioning device(s) 124 may be configured to determine the exact location of the agricultural machine 10 using a satellite navigation position system (e.g. a GPS, a Galileo positioning system, the Global Navigation satellite system (GLONASS), the BeiDou Satellite Navigation and Positioning system, and/or the like). In such an embodiment, the location determined by the positioning device(s) 124 may be transmitted to the controller(s) 102 (e.g., in the form of coordinates) and subsequently stored within the location database 122 for subsequent processing and/or analysis.

Additionally, in several embodiments, the location data stored within the location database 122 may also be correlated to the image data stored within the image database 118. For instance, in one embodiment, the location coordinates derived from the positioning device(s) 124 and the image(s) captured by the imaging device(s) 104 may both be time-stamped. In such an embodiment, the time-stamped data may allow each image captured by the imaging device(s) 104 to be matched or correlated to a corresponding set of location coordinates received from the positioning device(s) 124, thereby allowing the precise location of the portion of the field depicted within a given image to be known (or at least capable of calculation) by the controller(s) 102.

Moreover, by matching each image to a corresponding set of location coordinates, the controller(s) 102 may also be configured to generate or update a corresponding field map associated with the field being processed. For example, in instances in which the controller(s) 102 already includes a field map stored within its memory 112 that includes location coordinates associated with various points across the field, each image captured by the imaging device(s) 104 may be mapped or correlated to a given location within the field map. Alternatively, based on the location data and the associated image data, the controller(s) 102 may be configured to generate a field map for the field that includes the geo-located images associated therewith.

Likewise, any crop residue data 120 derived from a particular set of image data (e.g., an image frame of the image data) can also be matched to a corresponding set of location coordinates. For example, the particular location data 122 associated with a particular set of image data 118 can simply be inherited by any crop residue data 120 produced based on or otherwise derived from such set of image data 118. Thus, based on the location data and the associated crop residue data, the controller(s) 102 may be configured to generate a field map for the field that describes, for each analyzed portion of the field, identifying the presence (and optionally the location) of any residue bunches and/or residue evenness.

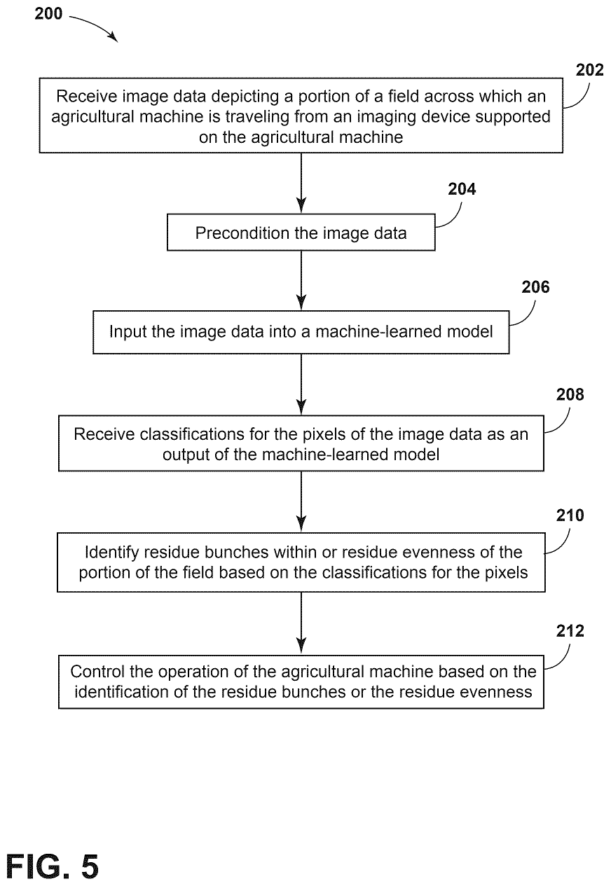

Referring still to FIG. 3, in several embodiments, the instructions 116 stored within the memory 112 of the controller(s) 102 may be executed by the processor(s) 110 to implement an image analysis module 126. In general, the image analysis module 126 may be configured to analyze the image data 118 to determine the crop residue data 120. In particular, as will be discussed further below, the image analysis module 126 can cooperatively operate with or otherwise leverage a machine-learned model 128 to analyze the image data 118 to determine the crop residue data 120. As an example, the image analysis module 126 can perform some or all of method 200 of FIG. 5 and/or method 300 of FIG. 6.

Moreover, as shown in FIG. 3, the instructions 116 stored within the memory 112 of the controller(s) 102 may also be executed by the processor(s) 110 to implement a machine-learned model 128. The machine-learned model 128 can be configured to receive image data and to process the image to classify pixels of the image data, such as having one of a residue classification or a not residue classification. In some embodiments, the machine-learned model 128 may be a machine-learned convolutional neural network. In other embodiments, the machine-learned model 128 may be a machine-learned transformer.

Referring still to FIG. 3, the instructions 116 stored within the memory 112 of the controller(s) 102 may also be executed by the processor(s) 110 to implement a control module 129. In general, the control module 129 may be configured to adjust the operation of the agricultural machine 10 by controlling one or more components of the agricultural machine 10. Specifically, in several embodiments, when residue bunches are identified within the field and/or an uneven distribution of residue is identified, the control module 129 may be configured to adjust the operation of the agricultural machine (e.g., the work vehicle 11 and/or the implement 12) in a manner that eliminates such residue bunches and/or improves the evenness of the residue.

In one example, one or more imaging devices 104 can be forward-looking image devices that collect image data of upcoming portions of the field. The image analysis module 126 can analyze the image data to classify the pixels of such image data and subsequently identify residue bunches within and/or the residue evenness of a portion of the field based on the pixel classifications. In some embodiments, the image analysis module 126 can determine one or more parameters associated with the identified residue bunches, such as their size, shape, location, etc. for such upcoming portion of the field. Thereafter, the control module 129 can adjust the operation of agricultural machine 10 based on the identified residue bunches and their associated parameters in the upcoming portion of the field. Thus, the system 100 can proactively manage various operational parameters of the agricultural machine 10 to account for upcoming crop residue conditions in upcoming portions of the field. For example, if an upcoming portion of the field has residue bunches, then the controller(s) 102 can, in anticipation of reaching such section, modify the operational parameters to account for such residue bunches. Similar control can be based on the determined residue evenness of the field.

In another example which may be in addition to, or an alternative to, the example provided above, the one or more imaging devices 104 can be rearward-looking image devices that collect image data of receding portions of the field that the agricultural machine 10 has recently operated upon. The image analysis module 126 can analyze the image data to classify the pixels of such image data and subsequently identify residue bunches within and/or the residue evenness of a portion of the field based on the pixel classifications. In some embodiments, the image analysis module 126 can determine one or more parameters associated with the identified residue bunches, such as their size, shape, location, etc. for such receding portions of the field. The control module 129 can adjust the operation of the agricultural machine 10 based on the identified residue bunches and their associated parameters for the receding portions of the field. Thus, the system 100 can reactively manage various operational parameters of the agricultural machine 10 based on observed outcomes associated with current settings of such operational parameters. Similar control can be based on the determined residue evenness of the field.

The controller(s) 102 may be configured to implement different control actions to adjust the operation of the agricultural machine 10 (e.g., the work vehicle 11 and/or the implement 12) in a manner that breaks up or prevents the formation of residue bunches and/or improves the residue evenness of the field. In one embodiment, the controller(s) 102 may be configured to increase or decrease the operational or ground speed of the implement 12 to break up or prevent residue bunch formation. For instance, as shown in FIG. 3, the controller(s) 102 may be communicatively coupled to both the engine 22 and the transmission 24 of the work vehicle 11. In such an embodiment, the controller(s) 102 may be configured to adjust the operation of the engine 22 and/or the transmission 24 in a manner that increases or decreases the ground speed of the work vehicle 11 and, thus, the ground speed of the implement 12, such as by transmitting suitable control signals for controlling an engine or speed governor (not shown) associated with the engine 22 and/or transmitting suitable control signals for controlling the engagement/disengagement of one or more clutches (not shown) provided in operative association with the transmission 24.

In some embodiments, the implement 12 can communicate with the work vehicle 11 to request or command a particular ground speed and/or a particular increase or decrease in ground speed from the work vehicle 11. For example, the implement 12 can include or otherwise leverage an ISOBUS Class 3 system to control the speed of the work vehicle 11.

In addition to adjusting the ground speed of the agricultural machine 10 (or as an alternative thereto), the controller(s) 102 may also be configured to adjust an operating parameter associated with the ground-engaging tools of the implement 12. For instance, as shown in FIG. 3, the controller(s) 102 may be communicatively coupled to one or more valves 130 configured to regulate the supply of fluid (e.g., hydraulic fluid or air) to one or more corresponding actuators 56, 58, 60 of the implement 12. In such an embodiment, by regulating the supply of fluid to the actuator(s) 56, 58, 60, the controller(s) 102 may automatically adjust the relative positioning of, the penetration depth, the force being applied to, and/or any other suitable operating parameter associated with the ground-engaging tools of the implement 12. For example, increasing the penetration depth or the force being applied to the ground-engaging tools may bury more residue, thereby breaking up residue bunches for reducing the likelihood of residue bunch formation and/or improving the residue evenness of the field. Conversely, decreasing the penetration depth or the force being applied to the ground-engaging tools may result in a more even residue coverage, such as when residue bunches are not being formed within the field.

Moreover, as shown in FIG. 3, the controller(s) 102 may also include a communications interface 132 to communicate with any of the various other system components described herein. For instance, one or more communicative links or interfaces 134 (e.g., one or more data buses) may be provided between the communications interface 132 and the imaging device(s) 104 to allow images transmitted from the imaging device(s) 104 to be received by the controller(s) 102. Similarly, one or more communicative links or interfaces 136 (e.g., one or more data buses) may be provided between the communications interface 132 and the positioning device(s) 124 to allow the location information generated by the positioning device(s) 124 to be received by the controller(s) 102. Additionally, as shown in FIG. 3, one or more communicative links or interfaces 138 (e.g., one or more data buses) may be provided between the communications interface 132 and the engine 22, the transmission 24, the control valves 130, and/or the like to allow the controller(s) 102 to control the operation of such system components.

The controller(s) 102 (e.g., the image analysis module 126) may be configured to perform the above-referenced analysis for multiple imaged sections of the field. Each section can be analyzed individually or multiple sections can be analyzed in a batch (e.g., by concatenating imagery depicting such multiple sections).

Referring now to FIG. 4, according to an aspect of the present disclosure, the controller(s) 102 can store or include one or more machine-learned models 128. Specifically, the machine-learned model 128 can be configured to receive image data and to process the image data to classify the pixels of the image data, such as having one of a residue classification or a not residue classification. In some embodiments, the machine-learned model 128 may be a machine-learned convolutional neural network. In other embodiments, the machine-learned model 128 may be a machine-learned transformer. However, in further embodiments, the machine-learned model 128 may be any other suitable type of machine-learned model.

In some embodiments, the convolutional neural network can include a plurality of layers. The plurality of layers can include one or more convolutional layers, activation functions, pooling layers, and/or fully-connected layers. In some embodiments, the convolutional neural network can include a final layer. The final layer can be a fully-connected layer. The final layer can indicate the output of the network that assigns to the image data a particular one of the plurality of pre-defined levels of crop residue. In some embodiments, a softmax function applied by and to the final layer can provide the output.

Alternatively to the convolutional neural network, other forms of neural networks can be used. Example neural networks include feed-forward neural networks, recurrent neural networks (e.g., long short-term memory recurrent neural networks), or other forms of neural networks. Neural networks can include multiple connected layers of neurons and networks with one or more hidden layers can be referred to as “deep” neural networks. Typically, at least some of the neurons in a neural network include non-linear activation functions.

Additionally, as mentioned above, a transformer can be used. In some embodiments, the transformer may include one or more encoders, such as to extract features from the received image data capture high-level semantic information through progressive downsampling. Moreover, in such embodiments, the transformer may include one or more decoders, such as to progressively upsample the compressed features from the encoder, thereby recovering spatial details and assigning prediction labels to the image pixels.

As further examples, the machine-learned model 128 can include a regression model (e.g., logistic regression classifier); a support vector machine; one or more decision-tree based models (e.g., random forest models); an artificial neural network (“neural network”); a Bayes classifier; a K-nearest neighbor classifier; a texton-based classifier; and/or other types of models including both linear models and non-linear models. These models can be used in addition or alternatively to the machine-learned convolutional neural network. For example, these models can be used to receive imagery and to process the imagery to select a level of crop residue from a plurality of pre-defined levels of crop residue.

The machine-learned model 128 can receive image data and can process the image data to classify the pixels of the image data as having one of a residue classification or a not residue classification. As will be described below, such classifications of the pixels can be used to identify the presence of residue bunches within a portion of the field, the residue evenness of the portion of the field, and/or one or more parameters associated with the identified residue bunches, such as their, size, shape, location, etc.

In some embodiments, the machine-learned model can further provide, for each pixel classification, a numerical value descriptive of a degree to which it is believed that the input data should have the corresponding classification. In some instances, the numerical values provided by the machine-learned convolutional neural network can be referred to as “confidence scores” that are indicative of a respective confidence associated with the classification of the input. In some embodiments, the confidence scores can be compared to one or more thresholds when identifying the presence of residue bunches, the residue evenness, and/or the parameters associated with such residue bunches.

In some embodiments, the controller(s) 102 can receive the one or more machine-learned models 128 from the machine-learning computing system 150 over network 180 and can store the one or more machine-learned models 128 in the memory 112. The controller(s) 102 can then use or otherwise run the one or more machine-learned models 128 (e.g., by processor(s) 110).

The machine learning computing system 150 includes one or more processors 152 and a memory 154. The one or more processors 152 can be any suitable processing device such as described with reference to processor(s) 110. The memory 154 can include any suitable storage device such as described with reference to memory 112.

The memory 154 can store information that can be accessed by the one or more processors 152. For instance, the memory 154 (e.g., one or more non-transitory computer-readable storage mediums, memory devices) can store data 156 that can be obtained, received, accessed, written, manipulated, created, and/or stored. In some embodiments, the machine learning computing system 150 can obtain data from one or more memory device(s) that are remote from the system 150.

The memory 154 can also store computer-readable instructions 158 that can be executed by the one or more processors 152. The instructions 158 can be software written in any suitable programming language or can be implemented in hardware. Additionally, or alternatively, the instructions 158 can be executed in logically and/or virtually separate threads on processor(s) 152.

For example, the memory 154 can store instructions 158 that when executed by the one or more processors 152 cause the one or more processors 152 to perform any of the operations and/or functions described herein.

In some embodiments, the machine learning computing system 150 includes one or more server computing devices. If the machine learning computing system 150 includes multiple server computing devices, such server computing devices can operate according to various computing architectures, including, for example, sequential computing architectures, parallel computing architectures, or some combination thereof.

In addition to, or alternatively to, the model(s) 128 at the controller(s) 102, the machine learning computing system 150 can include one or more machine-learned models 140. For example, the models 140 can be the same as described above with reference to the model(s) 128.

In some embodiments, the machine learning computing system 150 can communicate with the controller(s) 102 according to a client-server relationship. For example, the machine learning computing system 150 can implement the machine-learned models 140 to provide a web service to the controller(s) 102. For example, the web service can provide image analysis for crop residue determination as a service.

Thus, machine-learned models 128 can be located and used at the controller(s) 102 and/or machine-learned models 140 can be located and used at the machine-learning computing system 150.

In some embodiments, the machine-learning computing system 150 and/or the controller(s) 102 can train the machine-learned models 128 and/or 140 through use of a model trainer 160. The model trainer 160 can train the machine-learned models 128 and/or 140 using one or more training or learning algorithms. One example training technique is backwards propagation of errors (“backpropagation”). Gradient-based or other training techniques can be used.

In some embodiments, the model trainer 160 can perform supervised training techniques using a set of labeled training data 162. Alternatively, in other embodiments, the model trainer 160 can perform unsupervised training techniques using a set of unlabeled training data 162. The model trainer 160 can perform a number of generalization techniques to improve the generalization capability of the models being trained. Generalization techniques include weight decays, dropouts, or other techniques. The model trainer 160 can be implemented in hardware, software, firmware, or combinations thereof.

Thus, in some embodiments, the models can be trained at a centralized computing system (e.g., at “the factory”) and then distributed to (e.g., transferred to for storage by) specific controllers. Additionally, or alternatively, the models can be trained (or re-trained) based on additional training data generated by the user. This process may be referred to as “personalization” of the models and may allow the user to further train the models to provide improved (e.g., more accurate) predictions for unique field conditions experienced by the user.

The network(s) 180 can be any type of network or combination of networks that allows for communication between devices. In some embodiments, the network(s) can include one or more of a local area network, wide area network, the Internet, secure network, cellular network, mesh network, peer-to-peer communication link, and/or some combination thereof and can include any number of wired or wireless links. Communication over the network(s) 180 can be accomplished, for instance, via a communications interface using any type of protocol, protection scheme, encoding, format, packaging, etc.

The machine learning computing system 150 may also include a communications interface 164 to communicate with any of the various other system components described herein.

FIGS. 3 and 4 illustrate example computing systems that can be used to implement the present disclosure. Other computing systems can be used as well. For example, in some embodiments, the controller(s) 102 can include the model trainer 160 and the training dataset 162. In such embodiments, the machine-learned models 128 can be both trained and used locally at the controller(s) 102. As another example, in some embodiments, the controller(s) 102 is not connected to other computing systems.

Referring now to FIG. 5, a flow diagram of one embodiment of a method 200 for determining residue coverage parameters is illustrated in accordance with aspects of the present subject matter. In general, the method 200 will be described herein with reference to the agricultural machine 10 shown in FIGS. 1 and 2, as well as the various system components shown in FIGS. 3 and/or 4. However, it should be appreciated that the disclosed method 200 may be implemented with agricultural machines having any other suitable configurations and/or within systems having any other suitable system configuration. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 5, at (202), the method 200 may include receiving image data depicting a portion of a field across which an agricultural machine is traveling from an imaging device supported on the agricultural machine. For example, as indicated above, the controller(s) 102 may be coupled to one or more imaging devices 104 configured to capture images of various portions of the field.

In some embodiments, the image data received at (202) can include a single image frame. Thus, in some embodiments, the method 200 can be performed iteratively for each new image frame as such image frame is received. For example, method 200 can be performed iteratively in real-time as new images are received from the imaging devices 104 while the imaging devices 104 are moved throughout the field (e.g., as a result of being physically coupled to the agricultural machine 10 which is traveling across the agricultural field).

In other embodiments, the image data obtained at (202) can include a plurality of image frames. For example, the plurality of image frames can be concatenated or otherwise combined and processed as a single batch (e.g., by way of a single performance of method 200 over the batch).

At (204), the method 200 may include preconditioning the image data. For example, the image analysis module 126 of the controller(s) 102 may be configured to precondition the image data.

In some embodiments, preconditioning the image data can include performing histogram equalization (e.g., for brightness balance). In some embodiments, preconditioning the image data can include performing camera calibration (e.g., to rectify the image data so that lens distortion does not have as significant an effect). In some embodiments, preconditioning the image data can include enhancing the image to announce a specific feature. For example, the enhanced feature can be a soil and/or crop-specific feature. In some embodiments, preconditioning the image data can include changing the contrast, applying one or more filters, changing the reflectance or frequency wavelengths, and/or other processing operations. In some embodiments, the preconditioning performed at (204) can be specific to the particular machine-learned model being used.

Referring still to FIG. 5, at (206), the method 200 may include inputting the image data into a machine-learned model. The machine-learned model can be configured to receive image data and to process the image data to classify the pixels of the image data, such as classifying the pixels as having one or a residue classification or a not residue classification. For instance, as indicated above, the image analysis module 126 of the controller(s) 102 may be configured to input the image data into machine-learned model 128.

In some embodiments, the inputted image data can correspond to or otherwise include an entirety of the image data, such that all of the image data is analyzed. In other embodiments, the inputted image data can correspond to or otherwise include only a portion or subset of the image data. Using only a subset of the image data can enable reductions in processing time and resource requirements.

At (208), the method 200 may include receiving the classifications for the pixels of the image data as an output of the machine-learned model. The output of the machine-learned convolutional neural network can be a classification for each of a plurality of the pixels in a given set of image data (e.g., an image frame). The classification may be one of a residue classification or a not residue classification. For example, as indicated above, the image analysis module 126 of the controller(s) 102 may be configured to receive a respective classification for each pixel of a plurality of the pixels for each set of the image data (e.g., each image frame) as the output of the machine-learned model 128.

Additionally, at (210), the method 200 may include identifying residue bunches within and/or residue evenness of the portion of the field based on the classifications for the pixels. Specifically, in several embodiments, the image analysis module 126 of the controller(s) 102 may be configured to identify residue bunches within and/or the residue evenness of the portion of the field corresponding to image data for which the classification of the pixels was received at (208). In some embodiments, the image analysis module 126 may identify the residue bunches within and/or the residue evenness of the portion of the field based on the number of pixels having the residue classification that are touching each other. For example, when more than a threshold number of pixels having the residue classification that are touching each other, the image analysis module 126 may determine that such a group of pixels corresponds to a residue bunch. Moreover, the image analysis module 126 may determine the residue evenness based on the evenness or distribution of the pixels having the residue classification. In other embodiments, the image analysis module 126 may identify the residue bunches within the portion of the field based on the density of the pixels having the residue classification. For example, when the density of a group of pixels having the residue classification exceeds a threshold density, the image analysis module 126 may determine that such a group of pixels corresponds to a residue bunch. In addition, the image analysis module 126 may determine the residue evenness based on the density of the pixels having the residue classification.

Moreover, in some embodiments, at (210), one or more parameters associated with the identified residue bunches may be determined. For example, such parameters may include the size of the residue bunches, the shape of the residue bunches, the location of the residue bunches within the imaged portion of the field, and/or the like. Such parameters may be determined based on the classifications of the pixels.

Referring still to method 200 of FIG. 5, after identifying any residue bunches and/or the residue evenness at (210), then at (212), the method 200 may include controlling an operation of the agricultural machine as the agricultural machine travels across an agricultural field based at least in part on the identification of the residue bunches and/or the residue evenness. For example, as indicated above, the control module 129 of the controller(s) 102 of the disclosed system 100 may be configured to control the operation of the agricultural machine 10, such as by controlling one or more components of the work vehicle 11 and/or the implement 12 to allow an operation to be performed within the field (e.g., a tillage operation).

As one example, in some embodiments, when residue bunches or uneven residue coverage are identified at (208), the controller(s) 102 may be configured to actively adjust the operation of the agricultural machine 10 in a manner that breaks up the residue bunches, improves the residue evenness, and/or otherwise prevents further formation of residue bunches within the field following the operation being performed (e.g., a tillage operation), such as by adjusting the ground speed of the agricultural machine 10 and/or by adjusting one or more operating parameters associated with the ground-engaging elements of the agricultural machine 10, including, for example, the position of, the force being applied to, and/or other operational parameters associated with the ground-engaging elements.

Furthermore, in some embodiments, the method 200 may further include generating or updating a field map identifying the locations of residue bunches within and/or the residue evenness of the field based on the identification of such residue bunches at (208).

It is to be understood that the steps of the method 200 are performed by the computing system 100 upon loading and executing software code or instructions which are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system 100 described herein, such as the method 200, is implemented in software code or instructions that are tangibly stored on a tangible computer-readable medium. The computing system 100 loads the software code or instructions via a direct interface with the computer-readable medium or via a wired and/or wireless network. Upon loading and executing such software code or instructions by the computing system 100, the computing system 100 may perform any of the functionality of the computing system 100 described herein, including any steps of the method 200 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. An agricultural machine, comprising:
a frame;
an imaging device supported on the frame, the imaging device configured to capture image data depicting a portion of a field across which the agricultural machine is traveling; and
a computing system communicatively coupled to the imaging device, the computing system including one or more processors and one or more non-transitory computer-readable media that collectively store:
a machine-learned model configured to receive the image data and to process the image data to output classifications for pixels of the image data; and
instructions that, when executed by the one or more processors, configure the computing system to perform operations, the operations comprising:
receiving the image data from the imaging device;
inputting the image data into the machine-learned model;
receiving the classifications for the pixels of the image data as an output of the machine-learned model; and
identifying residue bunches within or residue evenness of the portion of the field based on the classification for the pixels.

2. The agricultural machine of claim 1, wherein the operations further comprise controlling an operation of the agricultural machine based on the identification of the residue bunches or the residue evenness.

3. The agricultural machine of claim 2, further comprising:
a ground-engaging tool supported on the frame,
wherein when controlling the operation of the agricultural machine, the operations further comprise adjusting a position of or a force being applied to the ground-engaging tool.

4. The agricultural machine of claim 1, wherein the machine-learned model is a convolutional neural network.

5. The agricultural machine of claim 1, wherein the machine-learned model is a transformer.

6. A computing system, comprising:
one or more processors; and
one or more non-transitory computer-readable media that collectively store:
a machine-learned model configured to receive image data and to process the image data to output classifications for pixels of the image data; and
instructions that, when executed by the one or more processors, configure the computing system to perform operations, the operations comprising:
receiving the image data from an imaging device supported on an agricultural machine, the image data depicting a portion of a field across which the agricultural machine is traveling;
inputting the image data into the machine-learned model;
receiving the classifications for the pixels of the image data as an output of the machine-learned model; and
identifying residue bunches within or residue evenness of the portion of the field based on the classification for the pixels.

7. The computing system of claim 6, wherein the operations further comprise controlling an operation of the agricultural machine based on the identification of the residue bunches or the residue evenness.

8. The computing system of claim 7, wherein when controlling the operation of the agricultural machine, the operations further comprise adjusting a position of or a force being applied to ground-engaging tool of the agricultural machine.

9. The computing system of claim 6, wherein the machine-learned model is a convolutional neural network.

10. The computing system of claim 6, wherein the machine-learned model is a transformer.

11. The computing system of claim 6, wherein the classification for the pixels is one of a residue classification or a not residue classification.

12. The computing system of claim 11, wherein identifying the residue bunches or the residue evenness comprises identifying the residue bunches within or the residue evenness of the portion of the field based on a number of the pixels having the residue classification that are directly in contact with each other.

13. The computing system of claim 11, wherein identifying the residue bunches or the residue evenness comprises identifying the residue bunches within or the residue evenness of the portion of the field based on a density of the pixels having the residue classification.

14. The computing system of claim 6, wherein the image data comprises a plurality of image frames.

15. A computer-implemented method, comprising:
receiving, with a computing system comprising one or more computing devices, image data depicting a portion of a field across which an agricultural machine is traveling from an imaging device supported on the agricultural machine;
inputting, with the computing system, the image data into a machine-learned model configured to receive the image data and to process the image data to output classifications for pixels of the image data;
receiving, with the computing system, the classifications for the pixels of the image data as an output of the machine-learned model;
identifying, with the computing system, residue bunches within or residue evenness of the portion of the field based on the classifications for the pixels; and
controlling an operation of the agricultural machine based on the identification of the residue bunches or the residue evenness.

16. The method of claim 15, wherein the machine-learned model is a convolutional neural network.

17. The method of claim 15, wherein the machine-learned model is a transformer.

18. The method of claim 15, wherein the classification for the pixels is a residue classification or a not residue classification.

19. The method of claim 18, wherein identifying the residue bunches or the residue evenness comprises identifying the residue bunches within or the residue evenness of the portion of the field based on a number of the pixels having the residue classification that are touching.

20. The method of claim 18, wherein identifying the residue bunches or the residue evenness comprises identifying the residue bunches within or the residue evenness of the portion of the field based on a density of the pixels having the residue classification.
